(19) United States
(12) Patent Application Publication
(10) Pub. No.: US 2024/0200960 A1
(43) Pub. Date: Jun. 20, 2024

(54) USING HISTORICAL USER ROUTES TO RECOMMEND NAVIGATIONAL ROUTES

(71) Applicant: Google LLC, Mountain View, CA (US)

(72) Inventor: Dongeek Shin, Mountain View, CA (US)

(21) Appl. No.: 17/801,435

(22) PCT Filed: Feb. 22, 2022
(86) PCT No.: PCT/US2022/017198

§ 371 Date: Aug. 13, 2023

(51) Int. Cl. G01C 21/34

(52) U.S. Cl. CPC G01C 21/3484; G01C 21/343

(57) ABSTRACT

A computing system and method that can be used for a mapping system that can recommend paths for navigational routing to a primary user. More particularly, a primary user may be interested in navigational routes that secondary users, different from the primary user, have taken in the past. The mapping systems described herein can provide improved user navigational services by leveraging the insight that users who are connected (e.g., via social media, address books, etc.) may often be interested in visiting similar points of interest. More particularly, aspects of the present disclosure enable various interactions between connected users such as following in prior users' footsteps and taking a tour according to one or more prior users' route. Alternatively, aspects of the present disclosure enable an optimization of a primary user's navigational routing by leveraging the insight that the primary user may share interests with connected secondary users. Thus, the mapping system can generate a tailored navigational routing that guides the primary user optimally to the one or more predicted points of interests based on one or more historical navigational routings by connected secondary users.

### FIELD

The present disclosure relates generally to geographic information systems or other mapping applications. In particular, the present disclosure is directed to systems and methods for using historical user routes to recommend trips and stops.

### BACKGROUND

A client device such as a smartphone or a laptop computer can operate a browser, mapping application, or a geographic information system to provide maps and/or other geographic information and data to a user. For example, a user can search a map for one or more generalized destinations. As another example, a map can be provided in response to a web search query that implicitly calls for geographic results, such as when the search may be satisfied by a plurality of points of interest respectively having physical locations. Generally, the client device can communicate with a server over a network in order to obtain the appropriate geographic information to provide to the user.

Furthermore, once relevant points of interest have been identified, the user can interact with the geographic information system to receive further information about a particular point of interest. For example, the user may select a restaurant or other place. In response, the geographic information system can provide the user with a proposed route from the user's current or designated location to the identified point of interest.

As an example, one instance in which mapping applications or other means for obtaining geographic information are particularly useful is when a user is exploring an area with which the user is relatively unfamiliar. For example, the user can be on vacation, work travel, or simply in an unfamiliar location within their home city. As a result, the user can use a mapping application to navigate about the area of exploration and receive other useful geographic information including, for example, recommendations of places to visit. For example, a user might be visiting Washington DC and want to know where friends who made similar trips recommend.

Therefore, the use of additional signals concerning aggregate historical users' data in order to provide improved and more personalized point of interest search results and other recommendations is desirable.

### SUMMARY

Aspects and advantages of embodiments of the present disclosure will be set forth in part in the following description, or can be learned from the description, or can be learned through practice of the embodiments. One example aspect of the present disclosure is directed to a computer-implemented method for recommending destinations to a user. The method comprises a computing system receiving data descriptive of a primary user location of a primary user. The method comprises the computing system receiving data descriptive of a primary user input requesting generation of a navigational routing. The method comprises the computing system receiving content associated with a plurality of historical user navigational routings previously traversed by one or more secondary users that differ from the primary user. Each of the plurality of historical user navigational routings comprises one or more stops. The method comprises the computing system determining a proposed path for the navigational routing based at least in part on a combination of the one or more stops associated with the plurality of historical navigational routings. The method comprises the computing system providing the proposed path for the navigational routing for display to the primary user.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

A full and enabling description of the present disclosure, directed to one of ordinary skill in the art, is set forth in the specification, which makes reference to the appended figures, in which:

FIG. 1 depicts a block diagram of example computing systems according to example embodiments of the present disclosure.

FIG. 2 depicts a block diagram of an example computing system according to example embodiments of the present disclosure.

FIG. 3 depicts an example user interface of obtaining route results according to an example embodiment of the present disclosure:

FIG. 4 depicts an example user interface of obtaining augmented reality directions according to an example embodiment of the present disclosure; and

FIG. 5 depicts a flow chart of an example method for using aggregated historical users' data to provide suggested routes according to an example embodiment of the present disclosure.

### DETAILED DESCRIPTION

### Overview

Generally, the present disclosure is directed to a mapping system that can recommend paths for navigational routing to a primary user. More particularly, a primary user may be interested in navigational routes that secondary users, different from the primary user, have taken in the past. Therefore, example mapping systems described herein can include a maps aggregate tracer that can aggregate data directed to historical navigational routings that users have taken. The mapping system can predict at least one desirable historical navigational routing out of the plurality of historical navigational routings. For example, the mapping system can predict at least one desirable historical navigational routing based at least in part on the secondary user associated with the historical navigational routing.

Thus, the mapping systems described herein can provide improved user navigational services by leveraging the insight that users who are connected (e.g., via social media, address books, etc.) may often be interested in visiting similar points of interest. Therefore, for example, reviews or other data obtained from secondary users who have visited points of interest can be used to influence a selection of recommended stops for a primary user located in the vicinity of the visited points of interest.

More particularly, aspects of the present disclosure enable various interactions between connected users such as following in prior users' footsteps and taking a tour according to one or more prior users' route. Alternatively, aspects of the present disclosure enable an optimization of a primary user's navigational routing by leveraging the insight that the primary user may share interests with connected secondary users. Thus, the mapping system can generate a tailored navigational routing that guides the primary user optimally to the one or more predicted points of interests based on one or more historical navigational routings by connected secondary users.

According to an aspect of the present disclosure, in some implementations, a computing system comprising one or more computing devices can receive data descriptive of a primary user location of a primary user. In particular, the computing system can receive data descriptive of a primary user input requesting generation of a navigational routing. Even more particularly, the computing system can receive content associated with a plurality of historical user navigational routings. For instance, the plurality of historical user navigational routings can be previously traversed. In particular, the plurality of historical user navigational routings can be previously traversed by one or more secondary users. Even more particularly, the one or more secondary users can differ from the primary user.

In some implementations, each of the plurality of historical user navigational routings can include one or more stops. In particular, the one or more stops can be associated with a ranking value. As a particular example, the primary user may be in Washington DC. The computing system can receive content associated with historical secondary user navigational routings wherein the received content is associated with historical trips secondary users have taken to Washington DC. Even more particularly, the secondary users may be the primary user's friends. The computing system can receive content associated with points of interest that the primary user's friends stopped at while on their trip to Washington DC and reviews the primary user's friends gave to those points of interest.

In some implementations, a proposed path for the navigational routing can be determined. In particular, the proposed path for the navigational routing can be determined based at least in part on the one or more stops associated with the plurality of historical navigational routings. Continuing the example from above, the computing system can determine a proposed path for the navigational routing based on the one or more stops associated with points of interest that the primary user's friends stopped at on their trips to Washington DC. For example, the computing system can include the Lincoln Monument in the proposed path for the navigational routing based at least in part on the primary user's friends all stopping at the Lincoln Monument and giving the Lincoln Monument high reviews (e.g., over 3 stars out of 5).

In some implementations, the proposed path for the navigational routings can be provided. In particular, the proposed path for the navigational routings can be provided for display to the primary user. Continuing the example from above, the computing system can surface a proposed path for navigating Washington DC to the primary user on a user interface such as a web mapping platform.

In some implementations, data descriptive of a second primary user input can be received. In particular, the data descriptive of the second primary user input can be directed to selecting at least one destination. For example, the second primary user input can be directed to the primary user indicating a desire to go to a particular location. As a particular example, the second primary user in put can be directed to the primary user indicating a desire to go to the Washington Monument. In particular, the data descriptive of the second primary user input selecting at least one destination can include data indicative of the second primary user input selecting one or more destinations out of one or more selectable destinations. Even more particularly, the one or more selectable destinations can be surfaced based at least in part on the one or more stops associated with the plurality of historical navigational routings. For example, the computing system can surface the most popular destinations based at least in part on the primary user's current location. As a particular example, a primary user located in Washington, DC can have selectable destinations such as the Washington Monument or the White House surfaced. In particular, the computing system can surface the Washington Monument, or the White House based on a value (e.g., a percentage, a majority, a number of, etc.) of historical navigational routings that have taken secondary users by the Washington Monument or the White House.

In some implementations, one or more additional stops can be determined. In particular, the one or more additional stops can be determined based at least in part on the plurality of historical navigational routings. To continue the example from above, the computing system can identify that a value of historical navigational routings (e.g., a percentage, a majority, a number of, etc.) that have gone past the Washington Monument have also gone past the Lincoln Monument.

In some implementations, the one or more additional stops can be based at least in part on a ranking value associated with the plurality of historical navigational routings. For instance, the secondary users may have reviewed stops that they took on their historical navigational routings. In particular, the secondary users may have assigned numerical values (e.g., 1-10) to stops that they took on their historical navigational routings. Even more particularly, the computing system can identify one or more additional stops if the additional stop has a particular review value (e.g., higher than a particular threshold, higher than another potential additional stop). To continue the example from above, the computing system can identify that a value of historical navigational routings (e.g., a percentage, a majority, a number of, etc.) that have gone past the Washington Monument have also gone past the Lincoln Monument as well as the Korean War Memorial. The computing system may compare reviews (e.g., numerical values) given to the Lincoln Monument and the Korean War Memorial.

In some implementations, the computing system can receive data indicating a primary user preference of number of additional stops to include in the proposed path. In some implementations, the computing system can receive data indicating a primary user preference for secondary user review value threshold.

In some implementations, the proposed path can be generated based at least in part on a combination of the data descriptive of a user location, the data descriptive of a second primary user input selecting at least one destination, and one or more additional stops. To continue the example from above, the computing system can generate a proposed path to the Washington Monument that includes a stop at the Lincoln Monument. The path to the Washington Monument including a stop at the Lincoln Monument can be optimized based on the user's current location. For example, the proposed path can direct the user by the Lincoln Monument first on the way to the Washington Monument if the route would be better optimized in that order (e.g., if the travel time would be shorter, if the travel distance would be shorter, etc.).

In some implementations, the plurality of historical user navigational routings can be associated with a plurality of connected users. For example, the plurality of connected users can include a plurality of connections via a social network. As another example, the plurality of connected users can include a plurality of connections via an address book contained in a primary user device associated with the primary user.

In some implementations, the computing system can receive data descriptive of a selection by the primary user of at least one connected user. In particular, the at least one connected user can be selected out of the plurality of connected users. In some cases, the computing system can receive data descriptive of a selection by the primary user of at least one connected user based on previous selections the primary user has made (e.g., contacts favorite list, social media favorites, etc.) Even more particularly, the computing system can obtain only content associated with the historical user navigational routings associated with the selected at least one connected user.

In some implementations, the computing system can determine a subset of the plurality of connected users. In particular, the computing system can determine a subset of the plurality of connected users based at least in part on contextual data. For example, the computing system can determine a subset of the plurality of connected users based at least in part on connected users the primary user was communicating with (e.g., within a threshold amount of time). In particular, the primary user may have been communicating with a secondary user via social media, text, email, phone, or any other communication method. Even more particularly, the computing system can determine a subset of the plurality of connected users based at least in part on communication content. Continuing the example from above, the computing system can determine at least one connected user that the primary user communicated with about Washington DC.

In some implementations, the ranking value can include a value associated the one or more stops being ranked hierarchically. In particular, the one or more stops can be ranked hierarchically based at least in part on reviews associated with the plurality of connected users. In particular, the computing system can weigh particular connected user reviews more heavily when determining the ranking value of potential stops. For example, the computing system can weigh the at least one selected connected user more heavily when determining the ranking value of potential stops. As another example, the computing system can weigh the at least one connected user that the primary user was discussing an upcoming trip with.

In some implementations, the ranking value can include a value associated with the one or more stops being ranked hierarchically based at least in part on aggregate user data. In particular, the ranking value can include a value based at least in part on secondary user reviews regardless of connection to primary user. Even more particularly, the ranking value can include a value based at least in part on a number of historical user visits. For example, a potential stop can receive a higher ranking value the more historical user visits are recorded.

In some implementations, providing, by the computing system, the proposed path for the navigational routing for display to the primary user can include providing the proposed path for the navigational routing for display to the primary user in an augmented reality interface. In particular, the computing system can present granular instructions for the primary user to engage with particular sights that a secondary user saw by surfacing an augmented reality interface after a user arrives at a secondary user stop. For example, the computing system may determine that the primary user has arrived by vehicle to a secondary user stop and is now walking. Now that the user is walking the computing system may determine that the user would desire more granular instructions such that the user can walk along the same path (e.g., the path can include pauses and angular directions) a secondary user did in order to see particular sights exactly as the secondary user had.

In some implementations, the plurality of aggregated navigational routings associated with the plurality of secondary user trips which occur within a distance from the primary user (e.g., within a particular threshold distance) can be surfaced for a user. In particular, the plurality of navigational routings can be labeled such that the primary user can identify which navigational routing is associated with which secondary user trip. For example, a particular navigational routing can be labeled “Dad—Spring 2002” to indicate that the primary user's father had taken this navigational routing in spring of 2002.

In some implementations, the plurality of aggregated secondary user trips which occur within a distance from the primary user can be combined into a particular number of potential navigational routings. In particular, the plurality of secondary user trips can be optimized to generate one or more potential navigational routings for the primary user. In particular, the one or more optimized potential navigational routings can be labeled such that the primary user can identify which secondary user trips were leveraged to generate the associated potential navigational routings. For example, a particular navigational routing can be labeled “optimized route of Dad—Spring 2002 and Sarah—Summer 2010” to indicate that the potential navigational routing has been optimized from two secondary user trips.

Thus, the present disclosure provides a mapping system that can recommend paths for navigational routing to a primary user. More particularly, example aspects of the present disclosure involve computing systems and computer-implemented methods for facilitating a primary user interested in navigational routes that secondary users, different from the primary user, have taken in the past in which a navigational route can be suggested based on data aggregated from historical navigational routes taken by secondary users.

The systems and methods of the present disclosure provide a number of technical effects and benefits. As one example of a technical effect, the proposed techniques are able to provide a more optimized method to generate a navigational route including suggested points of interest. In particular, the proposed systems enhance user efficiency by proactively predicting points of interest and automatically generating a navigational route which can guide a primary user on the optimal route to see the proactively predicted points of interest.

Furthermore, the proposed systems enhance user efficiency by automatically generating an optimized navigational route based on one or more historical navigational routes. By automatically generating an optimized navigational route, the proposed techniques allow users to reduce the rate and/or volume of data transmissions by reducing the amount of navigational routes generated. For example, in order to accommodate multiple desirable stops, a user may need to compare several navigational routes before determining the most optimized navigational route. However, by being presented the most optimized navigational route initially, the user no longer needs to compute multiple routes for comparison purposes. In particular, by reducing the number of navigational routes generated to achieve the same output of an optimized navigational route, the proposed systems can save additional computational resources (e.g., processor usage, memory usage, network bandwidth, etc.).

With reference now to the Figures, example embodiments of the present disclosure will be discussed in further detail.

### Example Devices and Systems

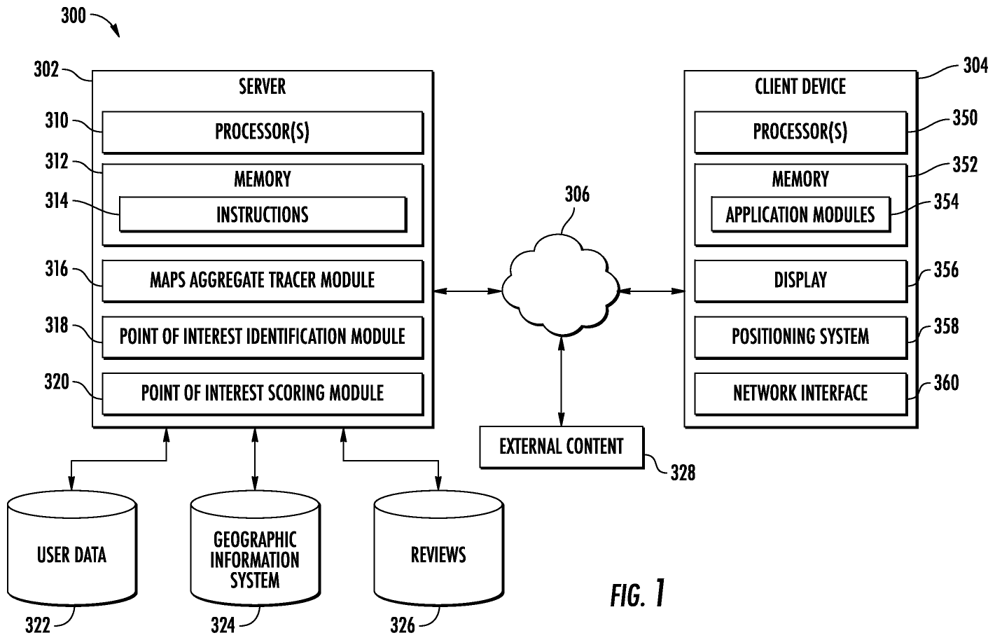

FIG. 1 depicts an example system 300 according to an example embodiment of the present disclosure. System 300 can include a client-server architecture, where a server 302 communicates with one or more client devices 304 over a network 306. Although one client device 304 is illustrated in FIG. 1, any number of client devices can be connected to server 302 over network 306.

Client device 304 can be, for example, a computing device having a processor 350 and a memory 352, such as a wireless mobile device, a personal digital assistant (PDA), smartphone, tablet, navigation system located in a vehicle, handheld GPS system, laptop computer, desktop computer, computing-enabled watch, computing-enabled eyeglasses, gaming console, embedded computing system, or other such devices/systems. In short, client device 304 can be any computer, device, or system that can interact with the server system 302 (sending and receiving data) to implement the present disclosure.

Processor 350 of client device 304 can be any suitable processing device and can be one processor or a plurality of processors that are operably connected. Memory 352 can include any number of computer-readable instructions or other stored data. In particular, memory 352 can include, store, or provide one or more application modules 354. When implemented by processor 350, application modules 354 can respectively cause or instruct processor 350 to perform operations consistent with the present disclosure, such as, for example, running a mapping application or a browser application in order to obtain and display personalized maps. Other modules can include a virtual wallet application module, a web-based email module, a game application module, or other suitable application modules.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example, computer executable instructions that are stored in a tangible computer-readable storage medium such as RAM hard disk or optical or magnetic media.

Client device 304 can include a display 356. Display 356 can be any suitable component(s) for providing a visualization of information, including, for example, touch-sensitive displays (e.g. resistive or capacitive touchscreens), monitors, LCD screens, LED screens (e.g. AMOLED), or other display technologies.

Client device 304 can further include a positioning system 358. Positioning system 358 can determine a current geographic location of client device 304 and communicate such geographic location to server 302 over network 306. The positioning system 358 can be any device or circuitry for analyzing the position of the client device 304. For example, the positioning system 358 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position.

In the instance in which the user consents to the use of positional or location data, the positioning system 358 can analyze the position of the client device 304 as the user moves around in the world and provides the current location of client device 304 to the server 302 over network 306. The current location of client device 304 can be displayed on the map and can influence aspects of the present disclosure, including scores assigned to point of interest search results.

Client device 304 can further include a network interface 360. Network interface 360 can include any suitable components for interfacing with one more networks, including for example, transmitters, receivers, ports, controllers, antennas, or other suitable components.

Server 302 can be implemented using one or more suitable computing devices and can include a processor 310 and a memory 312. For example, server 302 can be one server computing device or can be a plurality of server computing devices that are operatively connected. In the instance that server 302 includes a plurality of server computing devices, such plurality of server computing devices can be organized into any suitable computing architecture, including parallel computing architectures, sequential computing architectures, or some combination thereof.

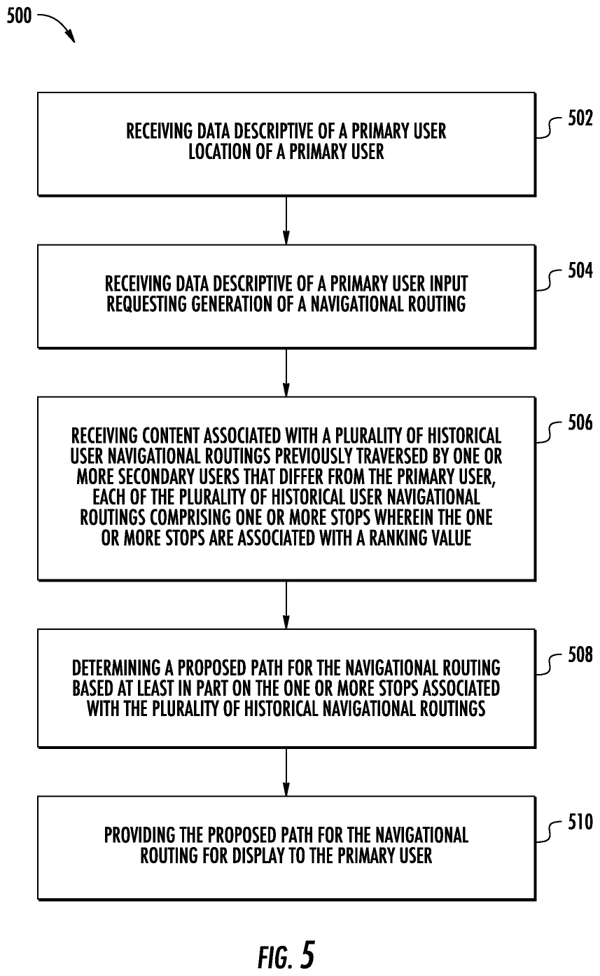

Processor 310 can be any suitable processing device and can be one processor or a plurality of processors which are operably connected. Memory 312 can store instructions 314 that cause processor 310 to perform operations to implement the present disclosure, including performing aspects of method (500) of FIG. 5.

Server 302 can include one or more modules for providing desired functionality. For example, server 302 can include a maps aggregate tracer module 316, a point of interest identification module 318, and a point of interest scoring module 320. Other modules to perform additional functionality can be included as well.

Server 302 can implement maps aggregate tracer module 316 to identify prior itineraries that historical users connected to the current user traveled. For example, maps aggregate tracer module 316 can use user data 322 such as a user location history, user email data, or other user data to identify historical user itineraries aligning with predicted user trips.

Server 302 can implement point of interest identification module 318 to identify a plurality of points of interest that are responsive to a search query. For example, point of interest identification module 318 can be implemented to interact with a geographic information system 324 to identify a plurality of points of interest.

Server 302 can implement point of interest scoring module to determine or calculate a score for each of a plurality of points of interest. For example, point of interest scoring module 320 can compute the score for each point of interest according to a scoring formula or scoring metric. In some embodiments, the scoring formula can be a weighted average that provides different weightings to a plurality of variables. The variables can be information relevant to the value of each point of interest as a search result (e.g. how well does the point of interest satisfy the search query, how close is the point of interest to the user's current location or the specified location, etc.).

Server 302 can be coupled to or in communication with one or more databases, including a database providing user data 322, a geographic information system 324, a database containing reviews 326, and external content 328. Although databases 322, 324, 326, and 328 are depicted in FIG. 1 as external to server 302, one or more of such databases can be included in memory 312 of server 302. Further, databases 322, 324, 326, and 328 can each correspond to a plurality of databases rather than a single data source.

User data 322 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; scheduling data; location data; SMS data; or other suitable data associated with a user account. Generally, according to an aspect of the present disclosure, such data can be analyzed to determine when a user is travelling and a place of accommodation at which such user may be staying.

Importantly, the above provided examples of user data 322 are simply provided for the purposes of illustrating potential data that could be analyzed, in some embodiments, to identify when a user is travelling and a place of accommodation at which such user may be staying. However, such user data is not collected, used, or analyzed unless the user has consented after being informed of what data is collected and how such data is used. Further, in some embodiments, the user can be provided with a tool to revoke or modify the scope of permissions. In addition, certain information or data can be treated in or more ways before it is stored or used, so that personally identifiable information is removed or stored in an encrypted fashion.

According to another aspect of the present disclosure, user data 322 can further store or provide a plurality of location histories respectively associated with a plurality of users. In particular, when a user elects to participate and has signed into her user account with respect to one or more of her computing devices, then such user computing device can periodically send a location update to server 302. Alternatively, the user location histories can be built and maintained by a computing system that is separate and unique from server 302 and the user location histories can simply be accessed by server 302.

For example, each location update can identify the presently active user account and a unique device identifier that corresponds to the device providing the update. Each location update can further include a location (e.g. latitude and longitude) and a timestamp identifying the date and time of day. In some implementations, location updates can further include an accuracy indicator and/or other identifying information such as an originating IP address or a WiFi or cell tower identifier.

Additional information can be used to build or supplement a user location history as well. As an example, whenever a user is logged into a user account and performs a web search or uses one or more applications, such as a mapping application, it is possible that such interaction can result in obtaining the user's location. Therefore, an entry can be formed in the associated user location history based on such interaction. As another example, if a user provides consent, transaction data from a digital wallet can be used to identify locations visited by the user.

All received location updates can be stored and associated with a particular user so that a user location history is built over time. Furthermore, in the event that the location reports provided by the user computing device simply provide a geo-location (e.g. a latitude and longitude), one or more algorithms can be applied to such location data to identify a particular point of interest that the user likely visited. Thus, the user location history for each user can provide a history of visits by such user to points of interest over time.

Geographic information system 324 can store or provide geospatial data to be used by server 302. Example geospatial data includes geographic imagery (e.g., digital maps, satellite images, aerial photographs, street-level photographs, synthetic models, etc.), tables, vector data (e.g. vector representations of roads, parcels, buildings, etc.), point of interest data, or other suitable geospatial data. Geographic information system 324 can be used by server 302 to provide navigational directions, perform point of interest searches, provide point of interest location or categorization data, determine distances, routes, or travel times between locations, or any other suitable use or task required or beneficial for performing the present disclosure.

Review database 326 can store a plurality of reviews respectively associated with a plurality of points of interest. Furthermore, information or statistics concerning the reviews can be included in the review database 326 as well. For example, the user who contributed each review and the date of contribution can be accessible by a review determination system.

Computer-based system 300 can further include external content 328. External content 328 can be any form of external content including news articles, webpages, video files, audio files, written descriptions, ratings, game content, social media content, photographs, commercial offers, or other suitable external content. Server system 302 and client device 304 can access external content 328 over network 306. External content 328 can be searched by server 302 according to known searching methods and can be ranked according to relevance, popularity, or other suitable attributes, including location-specific filtering or promotion.

Network 306 can be any type of communications network, such as a local area network (e.g., intranet), wide area network (e.g., Internet), or some combination thereof and can include any number of wired or wireless links. In general, communication between the server 302 and a client device 304 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Preferably, however, client device 304 can freely move throughout the world and communicate with server 302 is a wireless fashion.

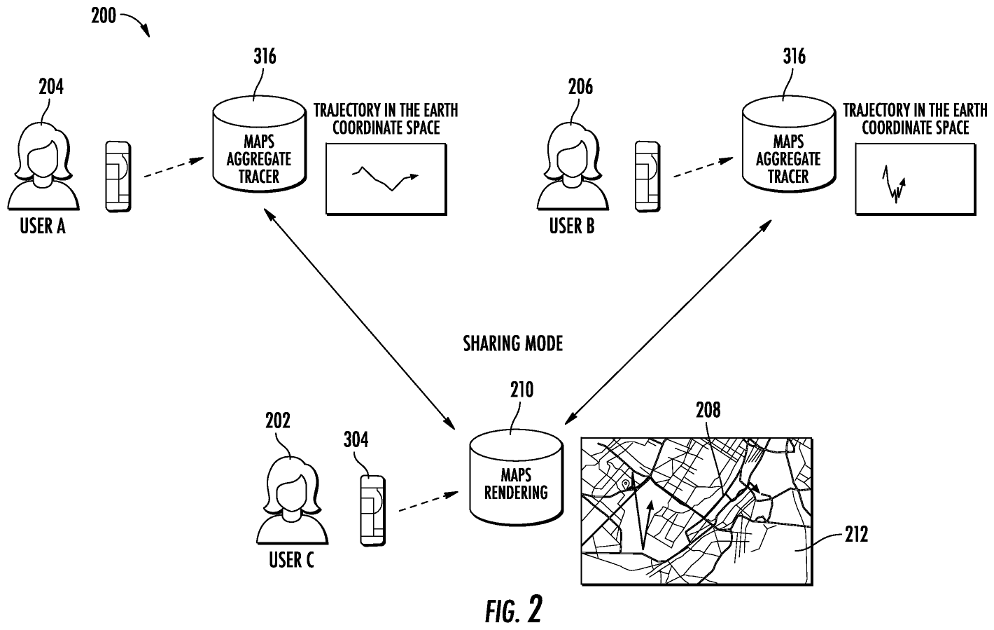

FIG. 2 depicts an example system 200 according to an example embodiment of the present disclosure. System 200 can include a client-server architecture, where a server communicates with one or more client devices 304. Although one client device 304 is illustrated in FIG. 2, any number of client devices can be connected to the server.

In some implementations, a primary user 202 may be connected to secondary users (e.g., a first secondary user 204 and a second secondary user 206). In particular, the primary user 202 can be connected to the secondary users 204 and 206 based at least in part on social media (e.g., friends, followers, etc.). Even more particularly, the primary user 202 can be connected to the secondary users 204 and 206 based at least in part on contacts (e.g., phone address book).

In some implementations, one or more secondary users 204 and 206 can take a trip which can be saved in the server. In particular, with reference to FIG. 1, data associated with trips taken by the secondary users can be saved in the maps aggregate tracer module 316. Although only data associated with two secondary user trips are shown as being saved in the maps aggregate tracer module 316, a plurality of secondary user trips can be saved in the maps aggregate tracer module 316. In particular, the data associated with trips taken by the secondary users can be compressed (e.g., lossless, lossy, etc.) such that the compressed data associated with trips taken by the secondary users can be saved in the maps aggregate tracer module 316.

In some implementations, the primary user client device 304 and the server can communicate such that the primary user client device 304 can generate a one or more potential navigational routings 208 based at least in part on the plurality of aggregated secondary user trips saved in the maps aggregate tracer module 316. In particular, the primary user client device 304 can generate the one or more potential navigational routings 208 based at least in part on a user location (e.g., based on the primary user client device 304 positioning system 358). Even more particularly, the primary user client device 304 can generate one or more potential navigational routings 208 using a maps renderer module 210 wherein the maps renderer module 210 can be contained in the primary user client device 304. Even more particularly, the one or more potential navigational routings 208 can be generated in a navigational routing interface 212. Specifically, the maps renderer module 210 can generate the one or more potential navigational routings 208 as an overlay. Even more specifically the maps renderer module 210 can generate the one or more potential navigational routings 208 as an overlay on top of a map interface.

### Example User Experience

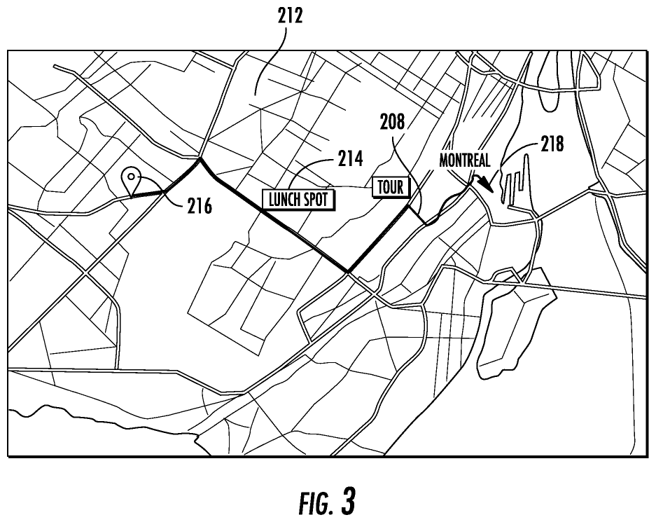

FIG. 3 depicts an example user interface of obtaining one or more potential navigational routings according to an example embodiment of the present disclosure. In particular, navigational routing interface 212 of a mapping application shows a potential navigational routing 208 displayed for a user.

In some implementations, the computing system can generate a potential navigational routing 208 most optimized on travel time based on the plurality of aggregated secondary user trips. In particular, the computing system can generate a potential navigational routing 208 based on the shortest travel time possible using particular transportation services (e.g., metro/train, car, bicycle, walk, any combination, etc.). For example, the computing system can determine what routes used in secondary user trips that were the quickest and recommend a navigational routing leveraging the quickest routes taken in secondary user trips.

In some implementations, the computing system can generate a potential navigational routing 208 most optimized to take the primary user by secondary users' most highly reviewed or most visited stops 214. In particular, the potential navigational routing 208 can suggest to the primary user stops that were highly reviewed by secondary users (e.g., food, museums, views, activities, stores, etc.). For instance, the potential navigational routing can take the user by a restaurant that was highly reviewed or most visited by secondary users. In particular, the computing system can determine based on the time that a user would be most likely to be interested in a particular genre of food (e.g., breakfast, brunch, lunch, dinner, snack, desert, etc.). Even more particularly, the computing system can generate the potential navigational routing based at least in part on a restaurant that was highly reviewed by secondary users for the particular genre of food predicted to be most interesting to a user.

In some implementations, the computing system can generate a potential navigational routing 208 that is not optimized on travel time but allows a primary user to optimize the number of highly reviewed or most visited stops included on the potential navigational routing 208. In particular, the computing system can leverage contextual data such as date and time to determine whether stops are open or not such that the generated potential navigational routing 208 can only include stops which the primary user could visit.

In some implementations, the computing system can generate a potential navigational routing 208 based on a particular start location 216 and/or end location 218. In some cases, the start location 216 and/or the end location 218 can be user input. In some cases, the start location 216 and/or the end location 218 can be automatically generated. For example, the start location 216 can be automatically generated based on contextual data such as primary user location. As another example, the end location 218 can be automatically generated based on a recommended stop generated by the potential navigational routing 208.

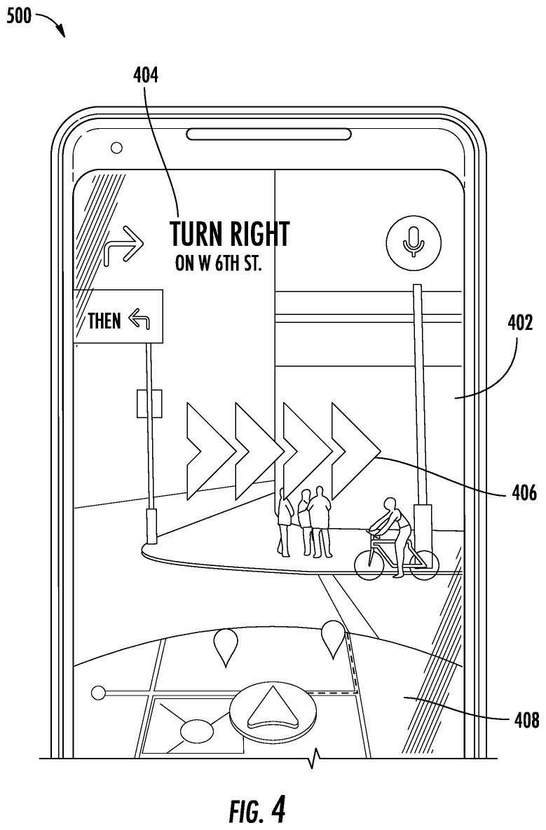

FIG. 4 depicts an example user interface of leveraging a potential navigational routing in an augmented reality interface according to an example embodiment of the present disclosure. In particular, augmented reality navigational routing interface 402 of a mapping application shows a potential navigational instruction 404 displayed for a user.

In some implementations, the computing system can present navigational instruction 404 for the primary user to use the potential navigational routing (e.g., the potential navigational routing 208 of FIGS. 2 and 3) in an augmented reality interface.

In some implementations, the augmented reality interface can include real-time imagery of the user's surroundings wherein navigational instructions 404 can be overlayed on top of the real-time imagery. In particular, an arrow icon 406 can be overlayed on the real-time imagery of the user's surroundings, indicating a direction for the user to move in order to follow the navigational routing.

In some implementations, the augmented reality interface can include a overhead map view 408. In particular, the overhead map view 408 can show surrounding streets so as to give context to the upcoming navigational instructions 404.

In some implementations, the computing system can present granular instructions for the primary user to engage with particular sights that a secondary user saw by surfacing an augmented reality interface after a user arrives at a secondary user stop. For example, the computing system may determine that the primary user has arrived by vehicle to a secondary user stop and is now walking. Now that the user is walking the computing system may determine that the user would desire more granular instructions such that the user can walk along the same path a secondary user did in order to see particular sights exactly as the secondary user had.

### Example Methods

FIG. 5 depicts a flow chart diagram of an example method to perform according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system comprising one or more computing devices can receive data descriptive of a primary user location of a primary user. In particular, a positioning system present on the primary user device can determine a location of the primary user device which can be associated with the location of the primary user.

At 504, the computing system can receive data. In particular, the computing system can receive data descriptive of a primary user input. Even more particularly, the data descriptive of a primary user input can be data descriptive of a primary user requesting generation of a navigational routing. For example, the primary user can open a web mapping platform application.

At 506, the computing system can receive content. In particular, the content can be associated with a plurality of historical user navigational routings. Even more particularly, the plurality of historical user navigational routings can be previously traversed. For example, the plurality of historical user navigational routings can be previously traversed by one or more secondary users that differ from the primary user. Specifically, each of the plurality of historical user navigational routings can include one or more stops. In particular, the one or more stops can be associated with a ranking value.

At 508, the computing system can determine a proposed path for the navigational routing. In particular, the proposed path for the navigational routing can be determined based at least in part on the one or more stops associated with the plurality of historical navigational routings.

At 510, the computing system can provide the proposed path for the navigational routing for display to the primary user. For example, the computing system can provide the proposed path for the navigational routing for display to the primary user on a web mapping platform. As another example, the computing system can provide the proposed path for the navigational routing for display to the primary user in augmented reality.

What is claimed is:

1. A computer-implemented method for recommending destinations to a user, the method comprising:
receiving, by a computing system comprising one or more computing devices, data descriptive of a primary user location of a primary user;
receiving, by the computing system, data descriptive of a primary user input requesting generation of a navigational routing;
receiving, by the computing system, content associated with a plurality of historical user navigational routings previously traversed by one or more secondary users that differ from the primary user, each of the plurality of historical user navigational routings comprising one or more stops;
determining, by the computing system, a proposed path for the navigational routing based at least in part on a combination of the one or more stops associated with the plurality of historical navigational routings; and
providing, by the computing system, the proposed path for the navigational routing for display to the primary user.

2. The computer-implemented method of claim 1 further comprising:
receiving, by the computing system, data descriptive of a second primary user input selecting at least one destination;
determining, by the computing system, one or more additional stops based at least in part on the plurality of historical navigational routings; and
generating, by the computing system, the proposed path based at least in part on a combination of the data descriptive of a user location, the data descriptive of a second primary user input selecting at least one destination, and one or more additional stops.

3. The computer-implemented method of claim 2, wherein the data descriptive of a second primary user input selecting at least one destination comprises data indicative of the second primary user input selecting one or more destinations out of one or more selectable destinations surfaced based at least in part on the one or more stops associated with the plurality of historical navigational routings.

4. The computer-implemented method of claim 3, wherein generating the path comprises including one or more additional stops based at least in part on a ranking value associated with the plurality of historical navigational routings.

5. The computer-implemented method of claim 1, wherein the plurality of historical user navigational routings are associated with a plurality of connected users, and wherein the plurality of connected users comprises a plurality of connections via a social network or address book contained in a primary user device associated with the primary user.

6. The computer-implemented method of claim 5, further comprising: receiving data descriptive of a selection by the primary user of at least one connected user out of the plurality of connected users; and obtaining only content associated with the historical user navigational routings associated with the selected at least one connected user.

7. The computer-implemented method of claim 5, further comprising: determining a subset of the plurality of connected users based at least in part on contextual data.

8. The computer-implemented method of claim 5, wherein the ranking value comprises a value associated with the one or more stops being ranked hierarchically based at least in part on reviews associated with the plurality of connected users.

9. The computer-implemented method of claim 1, wherein the ranking value comprises a value associated with the one or more stops being ranked hierarchically based at least in part on aggregate user data.

10. The computer-implemented method of claim 9, wherein the aggregate user data is directed to a number of historical user visits.

11. The computer-implemented method of claim 1, wherein providing, by the computing system, the proposed path for the navigational routing for display to the primary user comprises providing, by the computing system, the proposed path for the navigational routing for display to the primary user in augmented reality.

12. A computing system, comprising:
one or more processors; and
one or more non-transitory, computer-readable media that store instructions that when executed by the one or more processors cause the computing system to perform operations, the operations comprising:
receiving, by a computing system comprising one or more computing devices, data descriptive of a primary user location of a primary user;
receiving, by the computing system, data descriptive of a primary user input requesting generation of a navigational routing;
receiving, by the computing system, content associated with a plurality of historical user navigational routings previously traversed by one or more secondary users that differ from the primary user, each of the plurality of historical user navigational routings comprising one or more stops;
determining, by the computing system, a proposed path for the navigational routing based at least in part on a combination of the one or more stops associated with the plurality of historical navigational routings; and
providing, by the computing system, the proposed path for the navigational routing for display to the primary user.

13. The computing system of claim 12 further comprising:
receiving, by the computing system, data descriptive of a second primary user input selecting at least one destination;
determining, by the computing system, one or more additional stops based at least in part on the plurality of historical navigational routings;
generating, by the computing system, the proposed path based at least in part on a combination of the data descriptive of a user location, the data descriptive of a second primary user input selecting at least one destination, and one or more additional stops.

14. The computing system of claim 13, wherein the data descriptive of a second primary user input selecting at least one destination comprises data indicative of the second primary user input selecting one or more destinations out of one or more selectable destinations surfaced based at least in part on the one or more stops associated with the plurality of historical navigational routings.

15. The computing system of claim 14, wherein generating the path comprises including one or more additional stops based at least in part on a ranking value associated with the plurality of historical navigational routings.

16. The computing system of claim 12, wherein the plurality of historical user navigational routings are associated with a plurality of connected users, and wherein the plurality of connected users comprises a plurality of connections via a social network or address book contained in a primary user device associated with the primary user.

17. The computing system of claim 16, further comprising: receiving data descriptive of a selection by the primary user of at least one connected user out of the plurality of connected users; and obtaining only content associated with the historical user navigational routings associated with the selected at least one connected user.

18. The computing system of claim 16 further comprising: determining a subset of the plurality of connected users based at least in part on contextual data.

19. The computing system of claim 16, wherein the ranking value comprises a value associated with the one or more stops being ranked hierarchically based at least in part on reviews associated with the plurality of connected users.

20. One or more non-transitory computer-readable media that store instructions that, when executed by one or more processors of a computing system, cause the computing system to perform operations comprising:
receiving, by a computing system comprising one or more computing devices, data descriptive of a primary user location of a primary user;
receiving, by the computing system, data descriptive of a primary user input requesting generation of a navigational routing;
receiving, by the computing system, content associated with a plurality of historical user navigational routings previously traversed by one or more secondary users that differ from the primary user, each of the plurality of historical user navigational routings comprising one or more stops;
determining, by the computing system, a proposed path for the navigational routing based at least in part on a combination of the one or more stops associated with the plurality of historical navigational routings; and
providing, by the computing system, the proposed path for the navigational routing for display to the primary user.
